(19) United States
(12) Patent Application Publication
(10) Pub. No.: US 2025/0368573 A1
(43) Pub. Date: Dec. 4, 2025

(54) ECOFRIENDLY BIOPOLYMER ADMIXTURE FOR CEMENT AND CONCRETE APPLICATIONS

(71) Applicant: Blue Evolution Inc., Los Altos, CA (US)

(72) Inventors: Gowri Shah, Los Altos, CA (US); Jaime Martin Canton, Los Altos, CA (US); Beau G. Perry, Los Altos, CA (US)

(73) Assignee: Blue Evolution Inc., Los Altos, CA (US)

(21) Appl. No.: 18/676,013

(22) Filed: May 28, 2024

Related U.S. Application Data
(60) Provisional application No. 63/468,851, filed on May 25, 2023.

(51) Int. Cl. C04B 18/24; C04B 20/10; C04B 22/12; C04B 28/18; C04B 103/14; C04B 103/20; C04B 103/30; C04B 103/42; C04B 103/50; C04B 103/54; C04B 103/61; C04B 103/65; C04B 103/69

(52) U.S. Cl. CPC C04B 18/248; C04B 20/1029; C04B 22/124; C04B 28/18; C04B 2103/14; C04B 2103/20; C04B 2103/304; C04B 2103/42; C04B 2103/50; C04B 2103/54; C04B 2103/61; C04B 2103/65; C04B 2103/69

(57) ABSTRACT

Disclosed are compositions containing an Ulva extract and a concrete admixture suitable for inclusion in cement and concrete compositions, and methods of use thereof.

### CROSS-REFERENCE TO RELATED APPLICATIONS

This application claims the benefit of priority under 35 U.S.C. § 119(e) to U.S. Provisional Application No. 63/468,851, filed May 25, 2023, which is incorporated herein by reference in its entirety.

### BACKGROUND OF THE DISCLOSURE

Cement and concrete products used by various industries, such as the construction industry, generally consume significant amounts of energy during their manufacture. Cement production, including the production of clinker, an intermediate product of sintered material used as a binder, is essential for the vast majority of construction and infrastructure projects. However, cement production today contributes substantially to global warming given the significant amount of global carbon emissions emitted, that it is a main contributor to climate change.

Cement is the most widely used substance on earth following water and its production is estimated to be responsible for about 8% of all carbon emissions worldwide (Nie, et al., Journal of Cleaner Production 334:130270-81 (2022)). As reported in the British Broadcasting Corporation, “[i]f the cement industry were a country, it would be the third largest emitter in the world-behind China and the US” (Rodgers L. (2018 Dec. 18) Climate change: The massive CO2 emitter you may not know about. BBC). Of the carbon emissions generated from cement production, about 50% come from chemical processes and 40% come from burning of fuel. For example, the thermal decomposition of calcium carbonate into lime and carbon dioxide is a chemical process in cement production.

Most cements utilize one or more concrete admixtures that are designed to improve and control the workability, mechanical strength, durability, productivity, and other properties of the resulting concrete. Admixtures may be used to reduce the cost of concrete construction, modify the properties of hardened concrete, and/or ensure the quality of concrete during, for example, mixing, transporting, placing, and/or curing. Most commonly used admixtures such as plasticizers or superplasticizers in the cement and concrete industry are derived from fossil fuels, which contribute to greenhouse gas emissions and climate change.

Provided that it would not negatively impact any property of the final product, using a carbon neutral or carbon negative ingredient in cement production would reduce the amount of carbon emissions associated with cement production.

### SUMMARY OF THE DISCLOSURE

A first aspect of the present disclosure is directed to composition containing an Ulva extract and a concrete admixture.

Algal polysaccharides, such as ulvan, may both enhance a product's properties and promote eco-friendly sustainability by reducing global greenhouse gas emissions. These biopolymers offer numerous advantages as additives in cement as well as eco-friendly attributes. They can improve the workability and flow properties of cementitious materials, serving as natural water reducers. Furthermore, they have the potential to enhance the mechanical strength and durability of the concrete mixture.

Utilization of Ulva extracts, such as polysaccharide polymers, as cement admixtures can reduce the need for traditional chemical admixtures, which have demonstrated, negative environmental impacts. Algal polysaccharides biopolymers are considered eco-friendly additives due to their nature-based origin and renewable nature, having a low environmental impact. Algae can be grown rapidly and are abundant in various water bodies to address the volumes needed for production.

In some embodiments, the Ulva extract, e.g., a polysaccharide, is coated onto a nanomaterial. Nanomaterials may be biological, natural (inorganic), or synthetic nanomaterials. Biological nanomaterials, also referred herein as bionanomaterials and bio-nano, are derived from biological or biomass sources such as plants, bacteria, fungi, or algae. Bionanomaterials are eco-friendly, as they are derived from renewable sources. These particles possess unique properties and can be integrated into various materials, including algal polysaccharide biopolymers, through coating and other techniques. These bionanomaterials fill the gaps between cement particles, leading to denser concrete and reduced porosity. This enhancement contributes to improved compressive strength, tensile strength, and resistance to cracking and chemical deterioration.

Moreover, the polysaccharide-coated bionanomaterials reduce the surface tension of water, facilitating the uniform dispersion of cement particles. As a result, the concrete exhibits enhanced workability, reduced viscosity, and improved casting or pumping properties. Additionally, the incorporation of polysaccharide-coated bionanomaterials as admixtures holds promise for more eco-friendly and sustainable concrete production, essential to reducing global CO₂ and greenhouse gas emissions.

Another aspect of the present disclosure is directed to a package containing the composition containing an Ulva extract and a concrete admixture.

Another aspect of the present disclosure is directed to an unhardened cement composition comprising an Ulva extract, a concrete admixture, and cement.

Another aspect of the present disclosure is directed to a package comprising the unhardened cement composition.

Another aspect of the present disclosure is directed to an unhardened concrete composition comprising cement, an Ulva extract, an aggregate, and water.

Yet another aspect of the present disclosure is directed to a method of manufacturing concrete, mortar, stucco, or grout. The method entails mixing unhardened cement, an Ulva extract, and water to produce mortar or grout; or mixing unhardened cement, an Ulva extract, an aggregate, and water to produce concrete or stucco.

The presence of the Ulva extract may enhance one or more properties of concrete, such as tensile strength and durability. Being that it generates less CO₂, Ulva extracts may serve as an eco-friendly alternative to ingredients traditionally used in these industries. The replaced ingredient's production would otherwise release CO₂, whereas growth of Ulva from which the Ulva extract is produced, fixes CO₂ during growth and is persevered (i.e., not release) from the concrete to which it is added. Further, the Ulva extract may increase the stability of the final product (e.g., hardened concrete).

### BRIEF DESCRIPTION OF THE DRAWINGS

FIG. 1 is a schematic illustrating two methods of ulvan extraction and purification.

FIG. 2 is a set of chemical structures illustrating aldobiuronic acids and ulvanobioses disaccharide repeating units of ulvan.

### DETAILED DESCRIPTION OF THE DISCLOSURE

Unless defined otherwise, all technical and scientific terms used herein have the same meaning as is commonly understood by one of skill in the art to which the subject matter herein belongs. As used in the specification and the appended claims, unless specified to the contrary, the following terms have the meaning indicated to facilitate the understanding of the present disclosure.

As used in the description and the appended claims, the singular forms “a”, “an”, and “the” mean “one or more” and therefore include plural referents unless the context clearly dictates otherwise. Thus, for example, reference to “a composition” includes mixtures of two or more such compositions, reference to “an extract” includes mixtures of two or more such extract, and the like.

Unless stated otherwise, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

The term “approximately” as used herein refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The transitional term “comprising,” which is synonymous with “including,” “containing,” or “characterized by,” is inclusive or open-ended and does not exclude additional, unrecited elements or method steps. By contrast, the transitional phrase “consisting of” excludes any element or method step not specified in the claim (or the specific element or method step with which the phrase “consisting of” is associated). The transitional phrase “consisting essentially of” limits the scope of a claim to the specified elements and method or steps and “unrecited elements and method steps that do not materially affect the basic and novel characteristic(s)” of the claimed disclosure.

### Compositions Containing an Ulva Extract

In one aspect, the disclosure provides a composition containing an Ulva extract and a concrete admixture. Ulva (Phylum Chlorophyta, Class Ulvophyceae, Order Ulvales, Family Ulvaceae) is a genus of green algae widely distributed throughout the world. Ulva species (spp.) are primarily marine taxa found in saline and salty waters, but some Ulva species can also proliferate in freshwater habitats. Ulva spp. are commonly referred to as sea lettuce.

Any Ulva spp. may be used as a source for an Ulva extract. In some embodiments, the Ulva extract is produced from Ulva lactuca, U. fasciata, U. ohnoi, U. prolifera, U. Armoricans, U. australis, U. rigida, U. linza, U reticulata, U. ralfsii, U. compressa, U. pertusa, U. intestinalis, U. flexuosa, U. californica, U. curvata, U. digitata, U. clathrate, U. scandinavica, U. adhaerens, U. spathulate, or a combination of two or more thereof. In some embodiments, the Ulva extract is produced from U. ohnoi, U. australis, U. ralfsii, or a combination of two or more thereof.

The term “Ulva extract” is used herein to broadly refer to whole Ulva (e.g., dried, pulverized, or biomass), or some fraction thereof e.g., a product (e.g., biopolymers) isolated or purified from Ulva. (Pharmacological Advances in Natural Product Drug Discovery (1^{st}ed) ed. G. Du, Academic Press Elsevier, 2020, Cambridge, Massachusetts). The Ulva extract may be produced by subjecting Ulva to pulverization, grinding, drying, digestion, extraction, or a combination of two or more techniques thereof.

Ulva extracts generally include Ulva biomass, dried Ulva, dried and pulverized Ulva, or an ulvan. The Ulva extract may be in the form of a dry powder, a dry fiber powder, or freeze-dried.

Ulva biomass extracts contain Ulva bulk material which has not been subject to drying. Ulva biomass extracts may can be altered from Ulva by cleaning, concentrating, processing, or a combination of two or more thereof. Processing may include purifying or extracting to obtain a mixture of more than one more Ulva-derived compounds and biopolymers. Typically, Ulva biomass extracts will have impurities removed. Ulva biomass extracts preferably are free of microorganisms, remain traceable to its source (i.e., Ulva), and are processed as soon as possible after harvesting to maintain freshness and quality.

Dried Ulva extracts contain Ulva biomass that have been subject to drying (dewatering). Macroalgae drying techniques are known in the art. See, e.g., Aresta et al., Full Process. Technol. 86:1679-1693 (2005); Valderrama et al., FAO Fisheries and Aquaculture Technical Paper 580 (2014), Fudholi et al., Energy Build. 68:121-129 (2014), and U.S. Pat. Nos. 9,248,590, 9,499,941, 10,421,216, and 11,039,622, and U.S. Patent Application Publication No. 2020/0045981.

Dried and pulverized Ulva extracts contain dried Ulva that have been pressed, crushed, or ground until the Ulva extract becomes a powder or a soft mass. Concrete compositions containing dried and pulverized Ulva have increased workability, increased binding properties, and reduced permeability as compared to concrete compositions that do not contain dried and pulverized Ulva. Techniques for producing pulverized macroalgae are known in the art. See, e.g., U.S. Pat. Nos. 5,508,033 and 9,447,199, and U.S. Patent Application Publication No. 2016/0074317. In some embodiments, the dried Ulva is in the form of a dry powder, a dry fiber powder, or freeze-dried. Methods of freeze-drying macroalgae are known in the art. See, e.g., U.S. Pat. Nos. 9,668,966, 9,980,995, 10,232,005, and 11,523,982.

Ulva extracts typically contain varying amounts of polysaccharides (e.g., starch, cellulose and ulvan), ash, lipids, minerals, and protein; the content of which will vary widely depending on the Ulva species, location of Ulva cultivation, growth conditions, and method of extraction.

In some embodiments, the Ulva extract contains about 10% to about 17% ash, about 20% to about 80% polysaccharides, about 1% to about 5% lipids, about 3.8% to about 11.7% minerals, and about 10% to about 20% protein. The mineral portion of the Ulva extract may contain about 0.2% to about 0.8% sodium, about 3% to about 8% potassium, about 0.4% to about 1.4% calcium, about 0.15% to about 0.6% magnesium, about 0.002% to about 0.01% manganese, about 0.02% to about 0.06% iron, about 0.001% to about 0.005% copper, about 0.004% to about 0.01% zinc, and about 0.1% to about 0.8% iodine. Ulva extracts which contain these minerals will contribute to the strength and durability of the concrete product. Ulva extracts containing protein may act as a binding agent. Concrete compositions containing protein derived from an Ulva extract have increased bond strength and/or increased flexural strength.

Representative examples of polysaccharides that may be contained in Ulva extracts include cellulose, starch and ulvan. Cellulose-containing Ulva extracts may act as a reinforcing agent and improve strength and durability of a concrete composition as compared to concrete compositions that do not contain Ulva extracts containing cellulose.

Concrete compositions containing starch derived from an Ulva extract may have increased workability and durability and reduced water absorption as compared to concrete compositions that do not contain Ulva extracts containing starch.

Ulvans are cell wall polysaccharides that contribute about 10% to about 45% dry weight of the Ulva biomass. The quantitative yield and the quality of ulvan can vary significantly depending on the source of the Ulva species, cultivation technique (wild or cultivated), pre-extraction process, extraction process, purification process, location, and storage. In some embodiments, the Ulva extract contains a dried and pulverized Ulva spp. with approximately 20% to approximately 35% ulvan. In some embodiments, the Ulva extract is substantially purified ulvan.

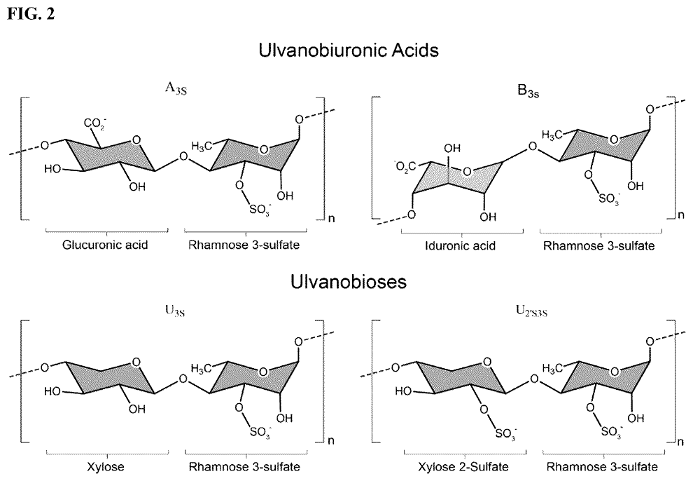

Ulvans are polyanionic sulfated heteropolysaccharides that contain rhamnose, xylose, glucuronic acid and iduronic acid, with the main repeating units of β-D-glucuronic acid (1→4)-α-L-rhamnose-3-sulfate and α-L-iduronic acid (1→4)-α-L-rhamnose-3-sulfate. The iduronic acid or glucuronic acid components may instead be a xylose unit (sulfated or non-sulfated) forming the characteristic monomers β-D-xylose (1→4)-α-L-rhamnose-3-sulfate and β-D-xylose-2-sulfate (1→4)-α-L-rhamnose-3-sulfate. Trace amounts of galactose and glucose can be found in ulvan. The chemical structures of the major disaccharide repeating units aldobiuronic acids, also referred to as ulvanobiuronic acid (types A and B) and minor disaccharide aldobioses, also referred to as ulvanobioses (type U) are illustrated in FIG. 2. (Tziveleka et al., Carbohydr. Polym. 218:355-370 (2019); Lakshmi et al., Biomolecules 10(7):991-20 (2020); Wahlström et al., Carbohydr Polym. 233:115852-9 (2020); Amor et al., Biomass Conversion and Biorefinery 13:3975-3985 (2023)).

Once the mole ratio of constituent sugars in ulvan from a particular source and batch is defined, the molecular structure can be altered through depolymerization and removal or addition of functional groups (e.g., sulfate esters). Altering the molecular structure enables optimizing and changing the functional properties of ulvan for a given composition and the final concrete product to which it is incorporated. In this regard, ulvan extract molecular weights (about 1 kDa to about 2000 kDa) and degree of sulfation (about 2.3% to about 40%) vary widely and have a large influence on physicochemical properties and biological activities. Depolymerization can be achieved through chemical and enzymatic hydrolysis with ulvan lyases. The degree of sulfation can be altered by addition of sulfate esters or removal of sulfate esters by solvolysis of the ulvan pyridinium salt or through base hydrolysis. Charge can be altered through manipulation of the degree of sulfation and by derivatization of the carboxylic acid groups (e.g., esterification and amide formation). Both the charge and the mole ratio of constituent sugars can be varied by reduction of glucuronic acid and iduronic acid to glucose and idose.

Ulvans isolated from blade Ulva species have been reported to have a higher sulfate ester content (and therefore higher overall sulfate content) than filamentous Ulva species. The degree of sulfation in ulvan has previously been correlated with anticoagulant, antihyperlipidemic and anti-viral activity. Therefore, ulvans isolated from blade and filamentous Ulva species may have different bioactivities. The degree of sulfation is also likely to affect the solution properties of ulvan (e.g., rheology). As the degree of sulfation of ulvan increases, the viscosity of a ulvan-containing composition also increases. Concrete admixtures with increased viscosity may enhance the workability of concrete by increasing its viscosity and improving the concrete's ability to mix, place, and finish (i.e., increased workability). Therefore, Ulva extracts sourced from a blade Ulva species may have higher sulfate content than Ulva extracts sourced from filamentous Ulva species and may be used in concrete compositions where increased viscosity and workability are advantageous.

The constituent sugar compositions of all purified ulvans may be determined by High Performance Anion-Exchange Chromatography (HPAEC) after hydrolysis of the polysaccharides to monosaccharides. The sugars identified from their elution times relative to a standard sugar mix (L-fucose, L-rhamnose, L-arabinose, D-galactose, D-glucose, D-glucosamine, D-mannose, D-xylose, D-ribose, D-galacturonic acid, D-glucuronic acid, and L-iduronic acid), quantified from response calibration curves of each sugar and expressed as μg of the anhydro-sugar (the form of sugar present in a polysaccharide) per mg of sample, the normalized mol % of each anhydro-sugar may also be calculated.

Ulvan from the blade species U. rigida has been reported to have the highest iduronic acid content at 18 mol %. Ulvans isolated from U. flexuosa and U. prolifera have been reported to have high proportions of rhamnose (56 and 60 mol %, respectively), and ulvans from U. ralfsii have been reported to contain high proportions of galactose (from about 10 to about 16 mol %). Despite the high proportions of galactose found in ulvans from filamentous U. ralfsii, the Rha to [GlcA+IdoA+Xyl] ratio for both species has been reported at 0.9:1.

The Molecular weight distribution of ulvans may be determined using size-exclusion chromatography coupled with multi-angle laser light scattering (SEC-MALLS). For example, in a study where ulvans were extracted from a single source of U. ohnoi (a blade species) using different biorefinery pre-treatments and extractants, the average molecular weight of the isolated ulvan varied from about 10.5 to about 312 kDa. Other studies have reported widely varying molecular weights for ulvans, e.g., about 2000 kDa from blade U. Armoricans, about 194 kDa from filamentous U. intestinalis, and about 1,218 kDa from filamentous U. prolifera.

Ulvan in the Ulva extract may have a molecular weight in the range of about 5 kDa to about 2,500 kDa and a degree of sulfation of about 9% to about 35%. In some embodiments, the sugar composition of ulvan is between about 5 to about 92.2 mol % rhamnose, about 2.6 to about 52 mol % glucuronic acid, about 0.6 to about 15.3 mol % iduronic acid, and about 0 to about 38 mol % xylose. In some embodiments, the sugar composition is about 45 mol % rhamnose, about 22.5 mol % glucuronic acid, about 5 mol % iduronic acid, and about 9.6 mol % xylose.

In some embodiments, the sugar composition of ulvan is from about 41 to about 53.1 mol % rhamnose, about 27 to about 30 mol % glucuronic acid, about 7.4 to about 10.1 mol % iduronic acid, and about 5.3 to about 5.7 mol % xylose.

Ulvan may be extracted from an Ulva spp. via numerous means known in the art, e.g., hot water, acid extraction, alkaline extraction, ultrasound extraction, microwave extraction, enzyme extraction, and pulse-field extraction. Additional ulvan extraction methods are described, for example, in Lahaye and Robic, Biomacromolecules 8(6):1765-74 (2007), Chiellini et al., Biomacromolecules 9(3):1007-13 (2008), U.S. Pat. No. 10,549,997, and U.S. Patent Application Publications Nos. 2009/0299053, 2022/0204730, and 2022/0289999.

The yield and quality of ulvan produced vary on the extraction method. The choice of extraction method is generally based around the physicochemical properties of the ulvan and its specific interactions with other components of the algal cell wall (e.g., starch, cellulose, xyloglucan and glucuronan) when the Ulva biomass is contacted with the solvent.

Hot water or aqueous organic solvents are the most common and conventional methods for extracting water-soluble polysaccharides (e.g., ulvan) from Ulva. These methods provide ulvan that contains glucuronic acid, glucose, arabinose, and xylose, with an average ulvan yield of about 25 to about 40%. Another extraction method involves adding about 0.05 to about 1% hydrochloric acid (pH 1.5 to 2), with an average ulvan yield of about 15 to about 45%. Enzyme extraction utilizes onozula RS, pectinase macerozyme, α-amylase, and proteinase K, which are suspended in the buffer. The ulvan yield with enzyme extraction is about 15 to about 47%. In addition to the three widely used methods, other methods include multilevel extraction, using water followed by NaCO₃ and NaOH solvents, with about 3.14 to about 6.50% yield. There is also a sequential extraction method that involves acidic solutions and ammonium oxalate with an average ulvan yield.

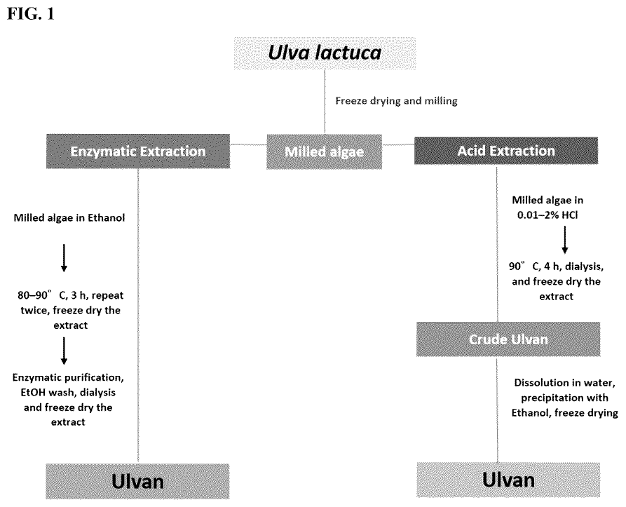

Concentration, solvent pH, extraction temperature, and duration may be varied to achieve the desired results, e.g., in terms of yield and quality of extraction (e.g., purity and molecular integrity). FIG. 1 schematically illustrates two representative ulvan extraction and purification methods from Ulva lactuca conducted at a temperature of about 80 to about 90° C., a pH of about 2 to about 4.5, and a duration of about 1 to about 3 h, and that result in high extraction yield, high selectivity, and low degradation.

In some embodiments, purification or fractionation is conducted by anion exchange chromatography (e.g., an AEC-Q-Sepharose column). The anion exchange chromatography is coupled with a single wavelength (280 nm) UV detector and a fraction collector. A chromatogram may be produced by colorimetric analysis of the collected fractions for uronic acid using glucuronic acid as a standard. Appropriate fractions may then be pooled and freeze-dried to yield purified ulvan.

### Nanomaterials

In some embodiments, at least a portion of the ulvan in the composition is coated onto one or more nanomaterials. Nanomaterials, including nanoparticles, nanotubes, nanofibers, micelles, and fibrils, improve concrete compressive strength and ability to withstand deflection without failure (ductility). Ulvan-coated nanomaterials (e.g., nanoparticles) may alter the viscosity and elasticity of the cement composition to which it is added. The alteration of the viscosity and elasticity depends on the other ingredients present in the cement composition. Depending on these other ingredients, the viscosity may be increased or decreased, the elasticity may be increased or decreased, or both the viscosity and the elasticity may be increased or decreased, as desired.

Nanomaterials that may be useful in the practice of the present disclosure may be classified in one of several ways. In some embodiments, the nanomaterials are classified based on their composition as carbon nanomaterials, organic nanomaterials, or inorganic materials. Carbon nanomaterials are made substantially from carbon, and include, for example, CNT, graphene, fullerenes, and carbon dots. Organic nanomaterials are made substantially from organic materials (i.e., materials containing hydrogen, carbon, and oxygen) include, for example, liposomes, dendrimers, polymers, and hybrids thereof. Inorganic nanomaterials are made substantially from non-organic materials (e.g., metals), and include, for example, metal nanomaterials, metal oxide nanomaterials, and ceramic nanomaterials.

In some embodiments, the nanomaterials include carbon nanomaterials, organic nanomaterials, or a combination thereof.

In some embodiments, the nanomaterials are classified based on their origin, as biological nanomaterials, natural nanomaterials, or synthetic nanomaterials. Biological nanomaterials, also known as bionanomaterials and bio-nano, are a type of nanoparticles derived from a living organism (e.g., as an extract) or as a byproduct of a living organism such as plants, bacteria, fungi, or algae, and are biodegradable, which reduces the amount of waste and pollutants, thereby reducing the carbon footprint of the concrete product to which they are incorporated. Furthermore, biological nanomaterials have low toxicity, reducing the risk of harm to both humans and the environment. See, e.g., Krishnaraj et al., Spectrochim. Acta A. Mol. Biomol. Spectrosc. 93:95-99 (2012); Prakash et al., Colloids Surf B Biointerfaces. 108:255-259 (2013); Sreekanth et al., J. Photochem. Photobiol. B 141:100-105 (2014); Ravikumar et al., J. Nanosci. Nanotechnol. 15 (12):9617-9623 (2015); Chokshi et al., RSC Adv. 6:72269-72274 (2016); Dhayalan et al., Nat. Prod. Res. 31(4):465-468 (2017); Stan et al., Acta Metall Sin. Engl. 29:228-236 (2016); Stan et al., Process Saf. Environ. 107:357-372 (2017); Otunola et al., Pharmacogn. Mag. 13(Suppl 2):S201-S208 (2017).

These biological nanomaterials possess unique properties and can be integrated into or coated onto various materials, including Ulva extracts, for example, ulvan polysaccharide biopolymers (e.g., through coating). These bionanomaterials may fill the gaps between cement particles, leading to denser concrete and reduced porosity. This enhancement contributes to improved compressive strength, tensile strength, and resistance to cracking and chemical deterioration. Moreover, the ulvan-coated bionanomaterials reduce the surface tension of water, facilitating the uniform dispersion of cement particles. As a result, the concrete exhibits enhanced workability, reduced viscosity, and improved casting or pumping properties.

Biological nanomaterials may be produced from polypeptides, polysaccharides, glycolipids, or a combination thereof. Biological nanomaterials produced from polypeptides are advantageous in their biodegradability, low toxicity, non-antigenicity, high stability, and binding capacity. Biological nanomaterials produced from polypeptides may bind water molecules in a composition and alter the composition's viscosity. Polypeptides used to produce biological nanomaterials include collagen, elastin, fibronectin, and soy protein. See, e.g., Chen and Remondetto, Trends Food Sci. Technol. 17:272-283 (2006); Elzoghby et al., J. Control. Release 153(3):206-216 (2011); Elzoghby et al., J. Control. Release 157(2):168-182 (2012); Gomes and Sobral, Molecules 27(1):60-30 (2021); McManus et al., Curr. Opin. Colloid Interface Sci. 22:73-79 (2016); Wan et al., Food Funct. 6:2876-2889 (2015); Oliveira et al., Food Res. Int. 102:759-767 (2017); Xue et al., Food Hydrocoll. 96:178-189 (2019); Keppler et al., Trends Food Sci. Technol. 101:38-49 (2020); Sun et al., Front. Bioeng. Biotechnol. 8:295 (2020).

Representative examples of polysaccharides used to produce biological nanomaterials include carrageenan, propylene glycol alginate, carboxymethylcellulose, and xanthan gum. See, e.g., Chen et al., Food Hydrocoll. 99:105334-10 (2020); Wei et al., Food Hydrocoll. 95:336-348 (2019); Liu et al., Food Hydrocoll. 79:450-461 (2018); Xuemei et al., Food Funct. 11:2380-2394 (2020); Aceituno-Medina et al., J. Funct. Foods. 12:332-341 (2015).

Biological nanomaterials may also be produced directly by a living organism, including bacteria (e.g., Pseudomonas aeruginosa, Thiobacillus, Serratia, and Stenotrophomonas spp.), fungi, or yeast (e.g., Saccharomyces cerevisiae) and subsequently purified from the living organism. See, e.g., Janssen et al., Colloid Surf. B. 6:115-129 (1996); Stefess et al., Appl. Microbiol. Biot. 45:169-175 (1996); Malhotra et al., Bioresour. Technol. 142:727-731 (2013); Mishra et al., Plos One 9(5):e97881-11 (2014); Mishra et al., Sci Rep. 7:45154-15 (2017); Singh et al., Proc. Natl. Acad. Sci. India Sect. B. 84:331-336 (2014). Biological nanomaterials (i.e., bio-nano) are distinct from natural (inorganic) nanomaterials and synthetic nanomaterials, as described below.

Natural nanomaterials are derived from natural inorganic processes including volcanic activity, combustion, precipitation, and oxidation. Sources of natural nanomaterials include surface fresh water, sea water, volcanic eruptions, combustion exhaust, atmospheric particulate matter, ore deposits, umber, and mineral wells. Representative examples of natural nanomaterials include nanoscopic ash, nanoscopic soot (carbon), silicate nanoparticles, iron nanoparticles, calcium carbonate nanoparticles, alumina nanoparticles, and bassanite (calcium sulfate) nanoparticles. See, e.g., Rauch et al., Environ. Sci. Technol. 39(21):8156-8162 (2005); Wu et al., Sci. Rep. 6:28817-11 (2016); Strambeanu et al., Nanoparticles' Promises and Risks: Characterization, Manipulation, and Potential Hazards to Humanity and the Environment. Springer International Publishing, p. 9-19 (2015) Cham, Switzerland; Guo et al., J. Mater. Chem. 1:274-42 (2013); Stawski et al., Nat. Commun. 7:11177-9 (2016); Faulstich et al., Int. Biodeterior. Biodegrad. 119:678-686 (2017); Hough et al., Ore Geol. Rev. 42:55-61 (2011); McGillicuddy et al., Sci. Total Environ. 575:231-246 (2017); Zhang et al., Water Res. 88:403-427 (2016).

In some embodiments, the natural nanomaterial is an ulvan-coated carbon nanomaterial produced from combustion waste. Additional natural nanomaterials produced from combustion and waste products thereof are known in the art. See, e.g., U.S. Pat. Nos. 7,157,066, 7,279,137, 7,335,344, 9,051,185, 9,409,779, and 9,738,524 and U.S. Patent Application Publication Nos. 2005/0163696, and 2007/0183959.

Synthetic nanomaterials may be produced from metals, metal oxides, ceramics, synthetic polymers, and dendrimers (branched, synthetic polymers). In some embodiments, the synthetic nanomaterials are metal nanoparticles, metal oxide nanoparticles, ceramic nanoparticles, synthetic polymer nanoparticles, dendrimer nanoparticles, or a combination of two or more thereof.

Representative examples of metal nanoparticles include silica nanoparticles, titanium dioxide nanoparticles, iron oxide nanoparticles, carbon nanotubes, or a combination of two or more thereof. Additional nanomaterials onto which ulvan may be coated are known in the art. See, e.g., U.S. Pat. Nos. 8,551,243, 8,585,934, 10,922,601, 11,352,301, and U.S. Patent Application Publication No. 2021/0355041.

Typically, the nanomaterials included in a composition will be from about 1 to about 100 nanometers in its shortest dimension. In some embodiments, the nanomaterial is a ulvan-coated nanoparticle that has a diameter from about 1 to about 100 nanometers. In some embodiments, the nanomaterial is a ulvan-coated nanotube that has a diameter from about 1 to about 100 nanometers and a length from about 0.1 nanometer to about 100 micrometers. In some embodiments, the nanomaterial is a ulvan-coated fibril that has a length of about 1 to about 10 micrometers and a width of about 1 to about 100 nanometers.

The process of coating nanomaterials with ulvan may vary depending on the composition of the nanomaterial. Typically, ulvan coating includes incubating a nanomaterial with ulvan for a period of time at a set pH and a set temperature. In some embodiments, ulvan coating includes stirring a nanomaterial with ulvan for about 30 to about 90 minutes at a pH from about 8 to about 10 at a temperature of about 50 to about 80° C., followed by a period of rest, without incubation (i.e., at or below room temperature) and without stirring. In some embodiments, ulvan is incubated with silver nanoparticles at about 80° C. and at about 7 pH for about 3 hours (See, e.g., Elgamouz et al., Nanomaterials (basel). 10(9):1861-19 (2020); Mansouri-Tehrani et al., Aquaculture 534:736260-10 (2021); Jacob et al., Biomass Conv. Bioref. s13399-021-01930-y:1-16 (2021); and El-Sheekh et al., Int. J. Phytoremediation 26:1-15 (2021)). The ulvan content in the ulvan-coated nanomaterial may be analyzed as known in the art to determine ulvan content, nanomaterial size, surface charge, stability, and composition.

Coating ulvan onto a nanomaterial may change one or more properties of the nanoparticle and the ulvan. For example, the charge and size of a nanomaterial may change after ulvan coating, the effective particle size of the bound ulvan may increase as it covers the surface of the nanomaterial, and nanomaterial clumping may decrease after ulvan coating, leading to dispersion and increased homogenous distribution of the nanoparticles throughout the composition (i.e., cement or concrete mix), resulting in improved mechanical performance of the composition.

### Concrete Admixture

As known in the art, concrete admixtures are used to improve the properties of concrete. The term “admixture” as used herein refers to functional materials added to a concrete batch immediately before or during mixing that add beneficial effects to the concrete batch, the beneficial effect depending on the admixture composition. Representative examples of such admixtures include plasticizers, superplasticizers, accelerators, dispersants, and water-reducing agents. Admixtures may be used to increase the workability of a cement mixture still in the nonset state, the strength of cement after application, and/or the material's water tightness. Further, admixtures may decrease the amount of water necessary to obtain workability and the amount of cement needed to create strong concrete.

Concrete admixtures reduce the cost of construction, modify properties of hardened concrete, ensure quality of concrete during mixing, transporting, placing, and curing. Admixtures may be classified as mineral admixtures or chemical admixtures.

### Mineral Admixtures

In some embodiments, the concrete admixture is a mineral concrete admixture. Common mineral admixtures may include fly ash, slag, ground granulated slag, metakaoline, silica fume, rice husk ash, or a combination of two or more thereof. Fly ash in admixtures typically makes up between about 15 to about 35% of the mass of the cement to which the admixture is added. The slag constituent in admixtures typically makes up between about 25 to about 70% of the mass of the cement to which the admixture is added. Metakoline in admixtures typically makes up between about 5 to about 10% of the mass of the cement to which the admixture is added. Silica fume in admixtures typically makes up between about 5 to about 10% of the mass of the cement to which the admixture is added.

Fly ash is the most commonly used pozzolan in concrete products. Fly ash is a by-product of thermal power generating stations. Commercially available fly ash is a finely divided residue that results from the combustion of pulverized coal and is carried from the combustion chamber of the furnace by exhaust gases. The American Society for Testing and Materials (ASTM) publication C618 (ASTM C618) “Standard Specification for Coal Ash and Raw or Calcined Natural Pozzolan for Use in Concrete” outlines the requirements of fly ash for use in concrete as a mineral admixture. ASTM C618 defines two classes of fly ash; Class F fly ash and Class C fly ash. The chief difference between these classes is the amount of calcium, silica, alumina, and iron content in the ash. In the presence of water, Class C fly ash hardens and gets stronger over time. Class C fly ash generally contains more than 20% lime. Unlike Class F, self-cementing Class C fly ash does not require an activator. Alkali and sulfate contents are generally higher in Class C fly ashes.

Fly ash is typically used at a replacement rate of 20-40% of ordinary cement (e.g., Portland cement). Fly ash can reduce the rate of slump loss of concrete under hot weather conditions and this reduction in slump loss is inversely proportional to the percentage of cement that was replaced (Soroka and Ravina, Cement and Concrete Composites 20(2-3):129-136 (1998)).

Slag is a glassy, granular material formed when molten, iron blast-furnace slag is rapidly chilled, typically by water sprays or immersion in water, and subsequently finely ground. Slag in mineral admixtures is hydraulic and can be added to cement as a supplementary cementing material.

Silica fume is a finely divided residue resulting from the production of elemental silicon or ferrosilicon alloys that is carried from a furnace by the exhaust gases. Silica fume, with or without fly ash or slag, is often used to make high-strength concrete products.

Additional mineral admixtures are described, for example, in U.S. Pat. Nos. 7,018,466, 7,255,731, 9,181,128, 9,802,864, 10,259,747, 10,913,688, 11,014,851, 11,161,791, and 11,505,505.

### Chemical Admixtures

In some embodiments, the concrete admixture is a chemical concrete admixture. Chemical admixtures may be classified as water reducing, retarding admixtures, accelerating, air entraining concrete, pozzolanic, damp-proofing, gas forming, air detraining, alkali aggregate expansion inhibiting, anti-washout, grouting, corrosion inhibiting, bonding, fungicidal, germicidal, insecticidal, or coloring admixtures. See, for example, ASTM C494 and AASHTO M194.

Water reducing admixtures may minimize the water demand in a concrete composition and increase the fluidity of a fresh cement mix with the same water to cement ratio, thereby improving the workability and ease of placement. Water reducing admixtures are also referred to as plasticizers and these are classified as normal plasticizers, mid-range plasticizers, and super plasticizers. Typically, normal plasticizers reduce the water demand up to about 10%, mid-range plasticizers reduce the water demand up to about 15%, and super plasticizers reduce the water demand up to about 30%. Water reducing admixtures may contain calcium, sodium, ammonium lignosulphonates, an acrylic polymer, polycarboxylate, poly-carboxylic acid, hydroxycarboxylic acid, a poly-carboxylate ether, or a combination of two or more thereof. Super plasticizers may contain sulfonated melamine formaldehyde, sulfonated naphthalene formaldehyde condensates, or a combination thereof.

Retarding admixtures may slow down the rate of hydration of a cement composition in the initial stage and increase the initial setting time of the concrete. Retarding admixtures are also referred to as retarders or set retarders and used especially in high temperature zones where concrete will set quickly. Retarding admixtures may contain soluble zinc salts, borates, calcium sulphate, gypsum, carbohydrate-based materials (e.g., starch and/or cellulose), or a combination of two or more thereof.

Accelerating admixtures may reduce the initial setting time of concrete compositions. Accelerating admixtures speed up the process of initial stage of hardening of concrete. Accelerating admixtures may contain triethanolamine, calcium formate, silica fume, calcium chloride, aluminum sulfate, silica gel, other acidic materials, or a combination of two or more thereof.

Air entraining admixtures may increase the durability of concrete under freezing and thawing conditions. Air entraining admixtures may contain a wood resin, an alkali salt, animal fat, vegetable oil, vinsol resin, darex, a blend of sodium alkyl benzene sulphonate, sodium ether sulphate and an alcohol ethoxylate, or a combination of two or more thereof.

Pozzolanic admixtures may contain clay, shale, volcanic tuffs, pumicite, fly ash, silica fume, blast furnace slag, rice husk ash, surkhi, or a combination of two or more thereof. Pozzolanic admixtures are used to prepare dense concrete compositions used for water retaining structures like dams, reservoirs, and water control structures. Pozzolanic admixtures may reduce the heat of hydration and thermal shrinkage of the concrete composition.

Damp proofing or water proofing admixtures may make the concrete structure impermeable against water and to prevent dampness on concrete surface. In addition to the water proofing property, damp proofing admixtures also serve as an accelerator in the early stage of concrete hardening. Damp proofing admixtures may contain aluminum sulfate, zinc sulfate, aluminum chloride, calcium chloride, silicate of soda, or a combination of two or more thereof

Gas forming chemical admixtures react with hydroxide generated by the hydration of cement and forms small hydrogen gas bubbles that are entrapped in the cement mix, which may help the concrete to counteract the settlement and bleeding issues. Gas forming admixtures may contain powdered zinc, aluminum powder, aluminum powder in combination with calcium hydroxide or hydrogen peroxide, activated carbon, hydrogen peroxide, or a combination of two or more thereof.

Air-detraining admixtures are used to remove excess air from voids in the concrete. Aggregates may also release gas into the concrete and excess entrained air may be removed by air-detraining admixtures. Air-detraining admixtures may contain ributyl phosphate, a silicone, a water insoluble alcohol, or a combination of two or more thereof.

Alkali aggregate expansion preventing admixtures may prevent the reaction of alkali of cement with silica present in an aggregate. The reaction results in a gel-like substance that causes volumetric expansion of the concrete which may lead to cracking and disintegration. Alkali aggregate expansion preventing admixtures may contain an aluminum powder, a lithium salt, or a combination of two or more thereof.

Anti-washout admixtures may be used in underwater concrete. It protects the concrete composition from being washed out under water pressure. Anti-washout admixtures may contain a natural rubber, a synthetic rubber, cellulose, or a combination of two or more thereof.

Grouting admixtures may be added to grout compositions to improve the properties according to the requirement thereof. Grouting admixtures may be used to change the setting time. Grouting admixtures may contain triethanolamine, calcium formate, silica fume, calcium chloride, silica gel, mucic acid, calcium sulphate, gypsum, starch, cellulose, or a combination of two or more thereof.

Corrosion preventing admixtures may be used to prevent or to slow down the process of corrosion of steel in reinforced concrete, especially when the concrete is exposed to water, industrial fumes, and chlorides. Corrosion preventing admixtures may contain sodium benzoate, sodium nitrate, sodium nitrite, or a combination of two or more thereof.

Bonding admixtures may be used to create a bond between old and fresh concrete surfaces. If fresh concrete is poured over a hardened concrete surface, there may be a chance of failure of the fresh concrete surface due to weak bonding with the old surface. To make the bond stronger, bonding admixtures may be added to the cement or mortar composition which is applied on the old concrete surface just before placing the fresh concrete. Bonding admixtures may contain natural rubber, synthetic rubber, polyvinyl chloride, polyvinyl acetate, or a combination of two or more thereof.

Fungicidal admixtures, germicidal admixtures, and insecticidal admixtures may be used to prevent the growth of bacteria, germs, and fungus on hardened concrete structures. Fungicidal admixtures, germicidal admixtures, and/or insecticidal admixtures may contain a polyhalogenated phenol, a copper compound, a dieledren emulsion, or a combination of two or more thereof.

Coloring admixtures are the pigments which produce color in the finished concrete. Coloring admixtures will typically not affect the concrete strength. Coloring admixtures may contain iron oxide, an iron hydroxide, barium manganite, chromium oxide, chromium hydroxide, ferrous oxide, carbon, manganese, raw umber, or a combination of two or more thereof.

Concrete is considered a brittle material that may fracture easily. Therefore, a chemical admixture may be used to improve the tensile strength of the concrete. Representative examples of chemicals to improve tensile strength include polymeric materials such as polyvinyl alcohol, polyacrylamide, or hydroxypropyl methyl cellulose.

Additional chemical admixtures are described, for example, in U.S. Pat. Nos. 7,638,563, 8,404,041, 11,130,714, and 11,148,972 and U.S. Patent Application Publication Nos. 2006/0180052, 2009/0234046, 2009/0312460, 2011/0054083, and 2012/0046393.

The amount of Ulva extract generally ranges from about 0.01% to about 10% of the total weight of the composition. In some embodiments, the amount of Ulva extract ranges from 0.1% to about 1.0%, of the total weight of the composition, and in some embodiments, from about 0.1% to about 0.5%, of the total weight of the composition containing the concrete admixture.

### Cement Compositions

In one aspect, the disclosure provides an unhardened cement composition containing an Ulva extract, a concrete admixture, and cement. While there are many types of cement, each with specific ingredients, practically all types of cement contain lime, silica, a metal oxide, and a sulfur-containing compound. Unhardened cement is a dry powdery substance, that does not contain added water. Unhardened cement may be mixed with water for form a mortar or grout. Unhardened cement may also be mixed with water and aggregate (e.g., sand and/or gravel) to form concrete or stucco.

The terms “cement” and “hydraulic cement” are used interchangeably herein to refer to any material that is capable of binding (i.e., cementing) aggregate particles together. As known in the art, the term “aggregate” refers to a granular material, such as sand, gravel, crushed stone, crushed hydraulic cement concrete, or iron blast-furnace slag, used provide mechanical strength to a composition and to decrease the amount of needed cement. The term “cement” as used herein does not include bone cements which are used to implant fixation in various Orthopedic and clinical surgery. Bone cements include polymethyl methacrylate, calcium phosphate cements and glass polyalkenoate (ionomer) cements.

The term “cementitious material” as used herein refers to any pozzolan or hydraulic cement. The term “pozzolan” as used herein refers to a siliceous or silico-aluminous material that will, in finely divided form and in the presence of moisture, chemically react with calcium hydroxide at ordinary temperatures to form compounds having cementitious properties.

The compositions of the present disclosure may be used in any type of cement. As known in the art, cement may be classified as ordinary Portland cement (OPC), Portland pozzolana cement, rapid hardening cement, quick setting cement, low heat cement, sulfates resisting cement, blast furnace slag cement, high alumina cement, white cement, colored cement, air entraining cement, expansive cement, and hydrographic cement.

OPC is manufactured and used worldwide for use in, for example, concretes, mortars, gouts, concrete blocks, wall putty, and plasters. OPC contains a calcareous material (usually limestone), silica and alumina (usually from clay or shale). OPC may also include iron oxide and magnesia. Portland pozzolana cement is produced from ground pozzolanic clinker and OPC. Portland pozzolana cement is highly resistant to chemical reactions and is used in, for example, marine structures, bridges, dams, and sewage works.

Rapid hardening cement is made with finely ground tricalcium silicate (Ca₃SiO₅) and OPC and is used in construction projects when hardening time needs to be short, for example, construction pavement. Low heat cement is made by restricting the percentage of tricalcium aluminate (Ca₃Al₂O₆) below 6% and increasing the percentage of dicalcium silicate (Ca₂SiO₄). Low heat cement is used in large construction projects, for example, gravity dams. Sulfate resisting cement is used for construction projects that come in contact with soil or groundwater, which have more than about 0.2 grams per liter sulfate salts. Quick setting cement has reduced proportions of gypsum and is used for construction projects that need quick setting times, for example, underwater structures and structures exposed to cold and/or rainy weather.

Blast furnace slag cement is made with a clinker that contains about 60% slag and is used in low budget construction projects. High Alumina cement is made by mixing calcined bauxite and lime with a clinker, where the alumina percentage is about 32% or more and the ratio of alumina to lime is within about 0.85 to about 1.3. High Alumina cement is used in construction projects that experience high temperatures, for example, refractories and foundries. White cement is similar to OPC but does not contain iron or oxide, which are replaced with higher proportions of lime and clay. Colored cement is OPC with about 5 to about 10% pigments added to produce a color of choice.

The Ulva extract is present in the admixture such that it makes up about 0.1 to about 1% by weight of the cement. In some embodiments, the Ulva extract makes up about 0.04 to about 0.25% by weight of the cement. In some embodiments, the Ulva extract makes up about 0.04 to about 0.09% by weight of the cement.

Lime contains calcium oxide (CaO) or calcium hydroxide. The CaO may be from limestone, chalk, shells, shale, or calcareous rock. The lime in the cement facilitates the formation of silicates and aluminates of calcium. If a cement composition does not contain sufficient amounts of lime, the strength and setting time of the resulting concrete product will be decreased. However, excess lime in the cement composition causes the concrete product to expand and disintegrate.

The metal oxide may be aluminum oxide (Al₂O₃), magnesium oxide (MgO), calcium oxide (CaO), iron oxide (Fe₂O₃), or a combination of two or more thereof.

The sulfur-containing compound may be a sulfate compound (e.g., calcium sulfate (CaSO₄)), a sulfur trioxide compound (also referred to as a “sulfate mineral”) (e.g., sulfur trioxide (SO₃)), or a combination of two or more thereof. The calcium sulfate may be in the form of gypsum (CaSO₄·2(H₂O)).

In some embodiments, the lime is about 60 to about 65% by weight of the cement, the silica is about 17 to about 25% by weight of the cement, the metal oxide is about 1 to about 15% by weight of the cement, and the sulfur-containing compound is about 0.1 to about 3.5% by weight of the cement.

### Packaging

In one aspect, the disclosure provides a package containing a composition containing an Ulva extract as described herein and a concrete admixture. The term “package” as used herein broadly refers to a container or object that is suitable for accommodating the composition and allowing for storage, display, transport, and/or ultimately dispensing the composition into a cement composition. The package will be capable of holding a dry composition. In some embodiments, the package is also capable of holding wet composition, e.g., a dry composition that has been mixed with water. In some embodiments, the package is capable of holding a liquid composition.

In one aspect, the disclosure provides a package containing an unhardened cement composition containing a mixture of an Ulva extract, concrete admixture, and cement.

In some embodiments, the package is a bag (e.g., plastic bag or paper bag), bucket, liquid tote, barrel, tank, or other container.

### Unhardened Concrete

In one aspect, the disclosure provides an unhardened concrete containing the cement composition, an aggregate, and water. The term “concrete” as used herein refers to a mixture of hydraulic cement or other cementitious material, aggregates, and water, with or without admixtures, fibers, or other cementitious materials. As concrete sets, the cement and water mixture hardens and binds the aggregates into a rocklike mass. The water causes the hardening of concrete through a process called hydration. Hydration is a chemical reaction in which the major compounds in cement form chemical bonds with water molecules and become hydrates or hydration products.

Aggregate typically includes gravel, sand, crushed rock, crushed recycled concrete, steel slag aggregate, or a combination of two or more thereof. Fine aggregate is typically defined as an aggregate material that passes through a 4.75 mm sieve. Coarse aggregate is typically defined as an aggregate material that passes through a 19 mm sieve. In some embodiments, the aggregate has a diameter less than about 9.6 mm, a diameter from about 9.5 to about 37.5 mm, or a diameter about 40 mm in diameter.

In some embodiments, the aggregate makes up about 60% to about 80% by weight of the concrete. In some embodiments, the concrete is made up of one part cement composition, two parts fine aggregate, to four parts coarse aggregate.

Additional components can be added to the concrete mix to affect the setting. For example, in addition to accelerating admixtures, a hardening agent, e.g., calcium chloride (CaCl₂) and HYDRASET®, may be added during the initial stages of setting to improve workability and increase strength while hastening the hydration of cement.

Fibers may also be incorporated into a cement or concrete mix to improve tensile strength. Representative examples of fibers include fibers of stainless steel, glass, or carbon. The fibers may be in the form of short, strand, sheet, non-woven fabric, or woven fabric fibers. Typically, fiber additives may make up about 1% of the volume of the concrete mix.

### Methods of Use

In one aspect, the disclosure provides a method of manufacturing concrete, mortar, stucco, or grout. The method entails mixing an unhardened cement, an Ulva extract, a concrete admixture, and water to produce mortar or grout; or mixing an unhardened cement, an Ulva extract, a concrete admixture, aggregate, and water to produce concrete or stucco. The ingredients may be added to the mixture in any order.

In some embodiments, the Ulva extract is first dissolved in water to form a paste before the mixing with the remaining ingredients (e.g., one or more of the cement and aggregate). In some embodiments, the composition containing the Ulva extract and the concrete admixture is first dissolved in water to form a paste before the mixing.

The mixing may be performed in a batch mixer, a continuous mixer, a central mixer, a volumetric mixer, or a high-shear mixer.

Batch mixers are the most common type of mixing device used in concrete production. Batch mixers are designed to mix concrete in batches, where each batch contains a specific amount of a composition containing an Ulva extract and a concrete admixture. These mixers can be either stationary or portable.

Continuous mixers are designed to mix concrete continuously, with compositions containing an Ulva extract and a concrete admixture being added at a constant rate. Continuous mixers are typically used in large-scale concrete production.

Central mixers are typically located at a central location on the construction site and are used to mix large quantities of concrete. They are designed to mix the concrete thoroughly and evenly, ensuring that a composition containing an Ulva extract and a concrete admixture is well-distributed throughout the mixture.

Volumetric mixers are designed to mix concrete on-site, as needed. They are typically used for small-scale concrete production, such as for residential construction projects.

High-shear mixers are designed to mix the concrete at a high speed, which helps to ensure that a composition containing an Ulva extract and a concrete admixture is well-distributed throughout the mixture. High-shear mixers are typically used for specialized concrete production applications. The choice of mixing device to which the composition containing an Ulva extract and a concrete admixture is added will depend on the specific requirements of the construction project and the properties that are desired in the final product.

Many of the above terms are known in the art and defined in the American Concrete Institute (ACI) standard ACI CT-13 entitled “ACI Concrete Terminology”, incorporated by reference herein.

All patent publications and non-patent publications are indicative of the level of skill of those skilled in the art to which this disclosure pertains. All these publications are herein incorporated by reference to the same extent as if each individual publication were specifically and individually indicated as being incorporated by reference.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A composition, comprising an Ulva extract and a concrete admixture.

2. The composition of claim 1, wherein the Ulva extract comprises Ulva biomass, dried Ulva, dried and pulverized Ulva, or an ulvan.

3. The composition of claim 1, wherein the Ulva extract comprises a dry powder, a dry fiber powder, or is freeze-dried.

4. The composition of claim 2, wherein the ulvan comprises from about 41 to about 53.1 mol % rhamnose, about 27 to about 30 mol % glucuronic acid, about 7.4 to about 10.1 mol % iduronic acid, and about 5.3 to about 5.7 mol % xylose.

5. The composition of claim 1, wherein the Ulva extract is obtained from Ulva lactuca, Ulva fasciata, Ulva ohnoi, Ulva prolifera, Ulva Armoricans, U. australis, U. rigida, U. linza, U reticulata, U. ralfsii, U. compressa, U. pertusa, U. intestinalis, U. flexuosa, U. californica, U. curvata, U. digitata, U. clathrate, U. scandinavica, U. adhaerens, U. spathulate, or a combination of two or more thereof.

6. The composition of claim 5, wherein the Ulva extract is obtained from Ulva ohnoi, Ulva australis, U. ralfsii, or a combination of two or more thereof.

7. The composition of claim 1, wherein the Ulva extract is a substantially purified ulvan.

8. The composition of claim 1, wherein at least a portion of the ulvan is coated onto nanomaterials.

9. The composition of claim 8, wherein the nanomaterials comprise nanoparticles that have a diameter from about 1 to about 100 nanometers; and/or
wherein the nanomaterials comprise biological nanomaterials, natural nanomaterials, synthetic nanomaterials, or a combination of two or more thereof; or
wherein the biological nanomaterials comprise polypeptide nanomaterials, polysaccharide nanomaterials, glycolipid nanomaterials, or a combination of two or more thereof; or
wherein the natural nanomaterials comprise nanoscopic ash, nanoscopic, silicate nanoparticles, iron nanoparticles, calcium carbonate nanoparticles, alumina nanoparticles, Bassanite (calcium sulfate) nanoparticles, or a combination of two or more thereof; or
wherein the synthetic nanomaterials comprise metal nanoparticles, metal oxide nanoparticles, ceramic nanoparticles, synthetic polymer nanoparticles, dendrimer nanoparticles, or a combination of two or more thereof; or
wherein the nanomaterials comprise carbon nanomaterials, organic nanomaterials, or a combination thereof.

10.-13. (canceled)

14. The composition of claim 9, wherein the metal nanoparticles are silica nanoparticles, titanium dioxide nanoparticles, iron oxide nanoparticles, carbon nanotubes, or a combination of two or more thereof.

15. (canceled)

16. The composition of claim 1, wherein the concrete admixture is a mineral concrete admixture or a chemical concrete admixture.

17. The composition of claim 16, wherein the mineral concrete admixture comprises fly ash, slag, ground granulated slag, metakaoline, silica fume, rice husk ash, or a combination of two or more thereof.

18. The composition of claim 16, wherein the chemical concrete admixture comprises a water reducing admixture, a retarding admixture, an accelerating admixture, an air entraining concrete admixture, a pozzolanic admixture, a damp-proofing admixture, a gas forming admixture, an air detraining admixture, an alkali aggregate expansion inhibiting admixture, an anti-washout admixture, a grouting admixture, a corrosion inhibiting admixture, a bonding admixture, a fungicidal admixture, a germicidal admixture, an insecticidal admixture, or a coloring admixture.

19. The composition of claim 18, wherein the water reducing admixture comprises calcium, sodium, ammonium lignosulphonates, an acrylic polymer, polycarboxylate, polycarboxylic acid, hydroxycarboxylic acid, a multi carboxylate ether, or a combination of two or more thereof; or
wherein the retarding admixture comprises calcium sulphate, gypsum, starch, cellulose, or a combination of two or more thereof; or
wherein the accelerating admixture comprises triethanolamine, calcium formate, silica fume, calcium chloride, silica gel, or a combination of two or more thereof; or
wherein the air entraining admixture comprises a wood resin, an alkali salt, animal fat, vegetable oil, vinsol resin, darex, a blend of sodium alkyl benzene sulphonate, sodium ether sulphate and an alcohol ethoxylate, or a combination of two or more thereof; or
wherein the pozzolanic admixture comprises clay, shale, volcanic tuffs, pumicite, fly ash, silica fume, blast furnace slag, rice husk ash, surkhi, or a combination of two or more thereof; or
wherein the damp proofing admixture or water proofing admixture comprises aluminum sulfate, zinc sulfate, aluminum chloride, calcium chloride, silicate of soda, or a combination of two or more thereof; or
wherein the gas forming admixture comprises aluminum powder, activated carbon, hydrogen peroxide, or a combination of two or more thereof; or
wherein the air-detraining admixture comprises ributyl phosphate, a silicone, a water insoluble alcohol, or a combination of two or more thereof; or
wherein the alkali aggregate expansion preventing admixture comprises an aluminum powder, a lithium salt, or a combination of two or more thereof; or
wherein the anti-washout admixture comprises a natural rubber, a synthetic rubber, cellulose, or a combination of two or more thereof; or
wherein the grouting admixture comprises triethanolamine, calcium formate, silica fume, calcium chloride, silica gel, mucic acid, calcium sulphate, gypsum, starch, cellulose, or a combination of two or more thereof; or
wherein the corrosion preventing admixture comprises sodium benzoate, sodium nitrate, sodium nitrite, or a combination of two or more thereof; or
wherein the bonding admixture comprises natural rubber, synthetic rubber, polyvinyl chloride, polyvinyl acetate, or a combination of two or more thereof; or
wherein the fungicidal admixture, the germicidal admixture, or the insecticidal admixture comprises a polyhalogenated phenol, a copper compound, a dieledren emulsion, or a combination of two or more thereof; or
wherein the coloring admixture comprises iron oxide, an iron hydroxide, barium manganite, chromium oxide, chromium hydroxide, ferrous oxide, carbon, manganese, raw umber, or a combination of two or more thereof.

20.-33. (canceled)

34. A package, comprising the composition of claim 1.

35. An unhardened cement composition, comprising a mixture of an Ulva extract, a concrete admixture, and a cement.

36. The unhardened cement composition of claim 35, wherein the Ulva extract is about 0.01 to about 10% by weight of the composition; or wherein the cement comprises lime, silica, a metal oxide, and a sulfur-containing compound.

37. (canceled)

38. The unhardened cement composition of claim 36, wherein the metal oxide comprises aluminum oxide (Al₂O₃), magnesium oxide (MgO), calcium oxide (CaO), iron oxide (Fe₂O₃), or a combination of two or more thereof; or wherein the lime comprises about 60 to about 65% by weight of the cement composition, the silica comprises about 17 to about 25% by weight of the cement composition, the metal oxide comprises about 1 to about 15% by weight of the cement composition and the sulfur-containing compound comprises about 0.1 to about 3.5% by weight of the cement composition.

39. The unhardened cement composition of claim 38, wherein the CaO is from limestone, chalk, shells, shale, or calcareous rock, and the sulfur-containing compound comprises calcium sulfate, sulfur trioxide, or a combination of two or more thereof.

40. (canceled)

41. The unhardened cement composition of claim 35, further comprising a clinker, wherein the clinker comprises tricalcium silicate, dicalcium silicate, tricalcium aluminate, and tetracalcium aluminate.

42. A package, comprising the unhardened cement composition of claim 35.

43. An unhardened concrete, comprising: the cement composition of claim 35, aggregate, and water.

44. The unhardened concrete of claim 43, wherein the aggregate comprises gravel, sand, crushed rock, crushed recycled concrete, steel slag aggregate, or a combination of two or more thereof; or
wherein the aggregate is less than about 9.6 mm in diameter, from about 9.5 to about 37.5 mm in diameter, or about 40 mm in diameter; or
wherein the aggregate comprises about 60% to about 80% by weight of the unhardened concrete.

45.-46 (canceled)

47. The unhardened concrete of claim 43, further comprising a hardening agent comprising calcium chloride (CaCl₂).

48. (canceled)

49. A method of manufacturing concrete, mortar, stucco, or grout, comprising:
mixing unhardened cement, an Ulva extract, and water to produce mortar or grout; or
mixing a concrete admixture, lime, silica, a metal oxide, a sulfur-containing compound, aggregate, and water to produce concrete or stucco.

50. The method of claim 49, wherein the Ulva extract is dissolved in water to form a paste before the mixing; or
wherein the Ulva extract is prepared with hot water, acid extraction, alkaline extraction, ultrasound extraction, microwave extraction, enzyme extraction, pulse-field extraction, or a combination of two or more thereof; or
wherein the Ulva extract comprises ulvan-coated nanoparticles, and the ulvan-coated nanoparticles alter the viscosity and elasticity of the cement composition; or
wherein the Ulva extract comprises dried and pulverized Ulva, and the Ulva extract increases binding properties of the cement composition; or
wherein the Ulva extract comprises cellulose, and the Ulva extract increases the strength and durability of the cement composition; or
wherein the Ulva extract comprises starch or a substantively purified ulvan, and the Ulva extract increases the workability of the cement composition and reduces the water absorption of the cement; or
wherein the mixing is performed in a batch mixer, a continuous mixer, a central mixer, a volumetric mixer, or a high-shear mixer.

51.-56 (canceled)
